(19) United States
(12) Patent Application Publication
(10) Pub. No.: US 2021/0272109 A1
(43) Pub. Date: Sep. 2, 2021

(54) SYNQVAULT ONE ACT

(71) Applicant: Symon Okhale Adeji, Oakland, CA (US)

(72) Inventor: Symon Okhale Adeji, Oakland, CA (US)

(21) Appl. No.: 16/803,656

(22) Filed: Feb. 27, 2020

(51) Int. Cl. G06Q 20/38; G06Q 40/02; G06Q 20/40; G06Q 20/36; G06Q 20/30; H04L 9/08; G06K 9/00; G10L 15/22

(52) U.S. Cl. CPC G06Q 20/3829; G06Q 40/02; G06Q 20/4014; G06Q 20/3674; G06Q 20/385; G10L 2015/223; H04L 9/0866; G06K 9/00335; G10L 15/22; G06Q 2220/00; G06Q 20/308

(57) ABSTRACT

The invention presents a method and system for withdraws and deposits of digital asset to and from a storage via connectivity using single act gesture control. One act is implemented on a device with an embedded synqvault and vaultstamp system which transmits requested data for withdrawal and deposit purposes. The requested transaction initializes from a display indicator or gesture. The device system works with the embedded synqvault and vaultstamp system disbursement or safe keep mechanism respectively for effective operation deployment. The device system interacts with the Synqvault system user interface to send data through the embedded Synqvault system as requested by the specific vault block until all verification requirements in each vault block are met confirming authorized user access to digital asset.

### TECHNICAL FIELD

The current invention relates to a cold storage embedded synqvault and vaultstamp system via connectivity to a device, wearable, robotic and internet of things, using a single act to accomplish the system setup goal with need to utilize withdraw and deposit from display or gesture recognition.

### BACKGROUND OF THE INVENTION

The Internet comprises a vast number of devices, wearables, robotics, and internet of things networks that are interconnected through communication links. SYNQ one act enables interconnected and independent devices, wearables, robotics and internet of things to carry out withdraw and deposit of digital asset transactions and exchanges respectively, via various application-layer protocol and interface systems. SYNQ one act withdraw and deposit system utilizes some unique functionalities as a result of its embedded mobile Synqvault system making the one act remote access shared key, dual-access key system, one act gesture recognition access and gesture control, biometrics one act access and verification system for withdraw and deposit, combination one act access and verification control system, Synqvault command system control, vault hybrid transfer system control, digital asset differentiation mechanism, Synqvault transaction verification, operation flow mechanism, Synqvault offline exclusion, online inclusion or combined hybrid mechanism integration, cold and hot wallet combined wallet in one vault standalone category, cold state wireless connectivity transfer Synqvault, shared remote access notification, one act withdraw and deposit, multiple device synchronization, one act digital asset synchronization, work in harmonization. Various functionalities are activated by a single act for easy verification of access per device or within a synchronized platform to access digital asset, transfer, exchange operation via SYNQ application programming interface systems or direct device integration solely to withdraw and deposit digital assets. The system is a decentralized one act platform for withdraw and deposit.

Each resource (e.g., device, wearable, robotic and Internet of things operations) is uniquely identifiable by various mechanism like hash algorithm, password, passcodes, cryptography, encryption, and blockchain methods etc. These operations are specific based on the most suitable use case device, wearable, robotic and Internet of things, etc. The system may require time lapse, dual access protocol, or both combination as a method to activate such operation as requested. Each request is programmed uniquely depending on the verification system desired for access by a chosen medium.

When a single act operation request is sent or received, the device, wearable, robotic and Internet of things then sends information to confirm and determine the operation requested by the system to withdraw and deposit digital asset. The request may contain verification to access digital asset, communication of other device operator available on individual device, wearable, robotic and Internet of things (e.g. the request may be an additional biometric clarification confirmation needed etc.).

SYNQ one act is built to enhance decentralized secured privacy operation to withdraw and deposit digital asset transaction, protection and exchanges, independently or in synchronization. The digital assets are data representation of value to users including; (e.g., cryptocurrency), (e.g., smart contract), (e.g., music), (e.g., books) or information etc., that are delivered digitally to the user over a specific device, wearable, robotic and Internet of things platform, which provide digital integration of embedded Synqvault storage system allowing network interactions and synchronization to activate one act withdraw and deposit using a single gesture. A user with multiple platforms may direct transfer from one platform to the other using one device to conduct withdraw and deposit operations only to the hybrid vault block. SYNQ one act mechanism also allows synchronization of platforms with limit to only the hybrid vault block. When the user has completed selection of the preferred medium for synchronization to be saved, the device, wearable, robotic and Internet of things system then prompts the user for identification by entering one-time passcode and other verification process to complete the withdraw and deposit operation in a synchronized environment. This user-specific withdraw and deposit process may include the receiver's name, the device key information for confirmation, displayed location for the withdraw and deposit and vise-versa. SYNC) one act mechanism is a cryptographic encrypted system developed to function with stationed and mobility devices, wearable, robotic and Internet of things, and other systems capable of integration. Typically, the embedded Synqvault system's primary assignment is to verify transactions, exchange and confirm withdraw, and deposit operation of all devices, wearable, robotic and Internet of things while scheduling transfer of digital asset.

Specific actions can be carried out from the display indicator or gesture for withdraw and deposit based on user preference to access content contained in the Synqvault. SYNQ one act has private, shared, and public key systems designed to integrate multi-user scenario or synchronization. The device owner(s) also have a pseudo key mechanism that allows management of outflow and inflow of digital asset without any access to the embedded Synqvault system. The mock key is created to carry out transaction with one time situation or integration for services that are not trusted with Synqvault information. The pseudo key is a dead-end miscellaneous vault used to authorize third party users to withdraw and deposit digital asset without sharing user's original credentials with the general public or selected individuals. The pseudo key individual independent vault box is not the same as the hybrid vault block, since the pseudo key is not attached to the Synqvault and is only located in the interface command, having its own lock mechanism and address to grant inflow but not outflow of resources. The pseudo private key is the instrument used to access the individual vault box to open or locked, ensuring the security of such records within that particular vault box. Security is a concern for SYNQ one act because data transmitted over the Internet may pass through various intermediate devices, wearable, robotic, and Internet of things systems as it is processed to its final destination. The data could be intercepted by an unscrupulous person at an intermediate system. To help ensure the security of the operations and records, various encryption techniques are used when transmitting such data between device, wearable, robotic and Internet of things platforms, such as hash algorithm etc. However when such encrypted data can be intercepted, because the data is encrypted, it is generally useless to the interceptor. Nevertheless, there is always a possibility that such operational data may be successfully decrypted by the interceptor. Therefore, it would be desirable to minimize the operational data transmitted when carrying withdraw and deposit online as embedded Synqvault system is highly effective in cold state (offline).

The selection of digital asset the display indicator is generally based on the “Synqvault transfer” model. When the user selects a transaction from the displayed indicator or gesture recognition single act, the device, wearable, robotic and Internet of things system instructively activates transactions within the Synqvault system for implementation. When the user is done selecting the asset to be transferred, then the asset specified in the Synqvault for transfer are “carried out” (i.e., withdraw or deposit).

The HTTL Synqvault model, which is the mother-vault, is constantly in a cold state (completely offline) not connected to the internet and cannot be online but still capable of encrypted connectivity via ultra-wideband [UWB], Bluetooth low energy [BLE], radio-frequency identification [RFID], etc. When a user selects a display act to make withdrawal, transactions are “carried out” automatically prompting the user for private or public key depending on the request. This action prompts the Synqvault transfer process of verification, identification, notification and accessibility etc. In the case of withdraw, the Synqvault single act paradox is experienced. Single act paradox is a secured privacy procedure that requires multiple one act interactions. Since vault block within the Synqvault are completely independent systems, in other to gain final access to digital asset credentials must be met, making the user go through the various Synqvault verification, identification, notification and confirmation etc., process. The procedural traffic engages various selected steps by a single act to get to the individual vault block then to gain complete access to the HTTL vault [mother-vault] can be enhanced or ignored depending on the user choice of withdraw operation or to use only the hybrid vault that enables quick buy, sell, earn or swap digital asset transfer etc., to save time.

While this process is puzzling for withdraw the opposite is the case to complete a deposit transaction which only needs one act to store up digital asset and move asset rapidly to activate and notify the assigned device indicator [ADI], encrypted data scanner [EDS] and foreign data detect [FDD] to verify for system infiltration, anti-money laundering identification, know your customer verification, spyware, privacy violation, hacker attack warning, identity key theft, fraud security breach and virus detection, then to the cold vault block 1 before progressing to cold vault block 2 then HTTL vault final block (as referred in FIG. 2), repeating the verification process to store up to the hybrid vault is not necessary but can be enabled for buy, sell, earn or swap etc., in case of a cryptocurrency. The hybrid wallet is the only vault block with online and offline capabilities which is barred from the other Synqvault systems when connected online. The hybrid wallet only interacts with the Synqvault system on an offline mode. All data are validated by the Synqvault system, then transferred to individual device, wearable, robotic and internet of things system for withdraw and deposit to be completed.

Withdraw and deposit without verification, notification, identification and encryption can be problematic for a couple of reasons. If a user withdraws or deposit with a corrupted device, then it is very easy for intruders to gain access to the digital asset data with no challenge. The hybrid wallet block can be reconfigured as a reactive prevention, keeping the hybrid wallet cold to prevent and mitigate such attack. Withdraw and deposit can be much faster in gaining access, if security is not a determining factor, however the hybrid wallet block is 95% faster in terms of accessibility to digital asset. This percentage rate only can only be achieved in the hybrid wallet, otherwise this operation makes the exchange of a single transaction cumbersome during withdraw and deposit when going through its internal system progression. However the system is built to accommodate time and security sensitivity with hybrid wallet block focusing on time as regards long-play security procedure while the HTTL Synqvault utilizes long-play security verifications, confirmation and alert systems, making each withdraw and deposit establish an independent operational verification, identification, notification and encryption process of transmission offline irrespective of the vault block engaged to reach the HTTL Synqvault block. The barred Synqvault module allows the hybrid wallet to play offline with cold state Synqvault system when moving assets by shutting out internet connection and any access from the device system while engaged. When the hybrid wallet is not offline during internal transfer, it is capable of corrupting the overall Synqvault system data transition, because any data transition over the internet to the HTTL Synqvault system is susceptible to being intercepted and decrypted.

### BRIEF OF THE INVENTION

An embodiment of the present invention provides a method and system for withdraw and deposit operation from a device, wearable, robotic and internet of things. This method and system for withdrawing and depositing digital asset to and from an embedded synqvault storage and vaultstamp system via connectivity. The SYNQ one act or gesture is implemented on a device with embedded synqvault and vaultstamp system which transmits requested data for withdrawal and deposit purposes, this transaction requested then initializes from a display indicator or gesture the final outcome. The embedded synqvault and vaultstamp system collects user data such as identification of the user, meet know your customer and anti-money laundering requirements for withdraw and deposit instructions etc., and verify for authentication system infiltration before transferring the data for final result when activated. The device system works hand-in-hand with the embedded synqvault and vaultstamp system disbursement or safe keep mechanism respectively for effective operation deployment. The embedded synqvault and vaultstamp system processes and sends a one-time passcode to instruct user to enter the unique requirement assigned to user for secured access and progress continuation, which then notify the assigned device indicator [ADI], encrypted data scanner [EDS] and foreign data detect [FDD] to verify for system infiltration, anti-money laundering identification requirements based on the amount and timeframe, know your customer verification, spyware, privacy violation, hacker attack warning, identity key theft, fraud security breach and virus detection, then progresses to initiate access to the embedded Synqvault system specifically to withdraw or deposit by a single act. The device system interacts with the Synqvault user interface to send data through the embedded synqvault and vaultstamp systems as requested, to the specific vault block until all verification requirements in each vault block are met confirming authorized user access to digital asset. The single act can be a combination of biometrics, key, encryption and password withdraw and deposit verification requirements.

SYNQ single act embedded system creates a one act validation affecting other functionalities along the way like the dual-access key system, one act gesture recognition access and gesture control, biometrics one act access and verification system for withdraw and deposit, Synqvault command system control, hybrid transfer system control, digital asset differentiation mechanism, Synqvault transaction flow mechanism, Synqvault offline exclusion and online inclusion mechanism, cold and hot wallet wireless connectivity, shared remote access withdraw and deposit notification, multiple device synchronization and digital asset synchronization to respond simultaneously to either a withdraw and deposit request in a device, wearable, robotic and internet of things systems availability. The withdraw and deposit process for internal verification, notification, access keys etc., that identifies the authentic user, require user the requirement accurately to function seamlessly from a single act display.

The display can be any act (e.g., gesture recognition and control, buy, earn, swap, transfer, send or receive withdraw and deposit of digital asset) performed to withdraw and deposit the specified digital data in response to the designated act being executed. The device system sends an encrypted message to the stipulated access-point requesting withdraw and deposit identified digital data. The encrypted system uses keys and password to identify additional data generated for withdraw and deposit transaction.

The encrypted system receives and stores the data for user to be accessed when using other device, wearable, robotic and internet of things systems with SYNQ one act capabilities so that the encrypted system can generate such withdraw and deposit. The encrypted system stores the received data in a cold vault associated with the owner's key, provision of these credentials then grants access to the device system.

### BRIEF EXPLANATION OF THE DRAWINGS

FIG. 1

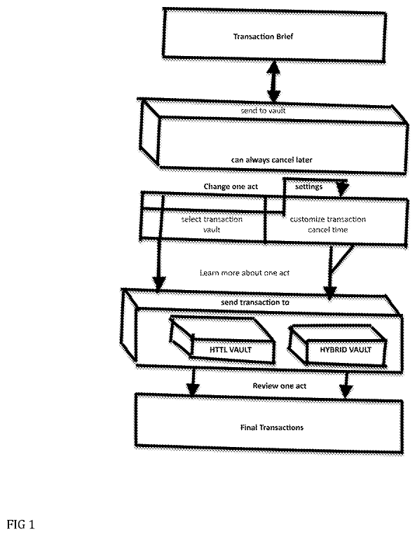

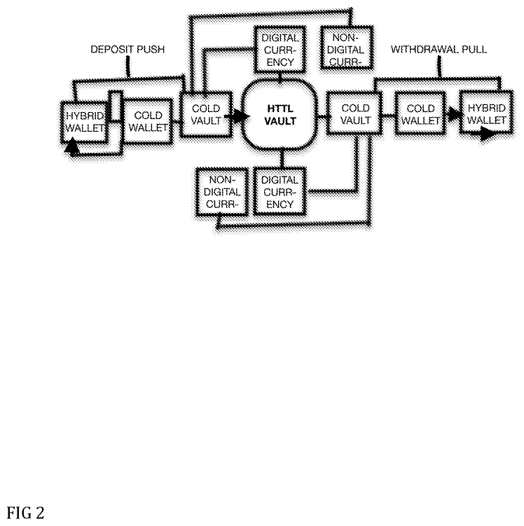

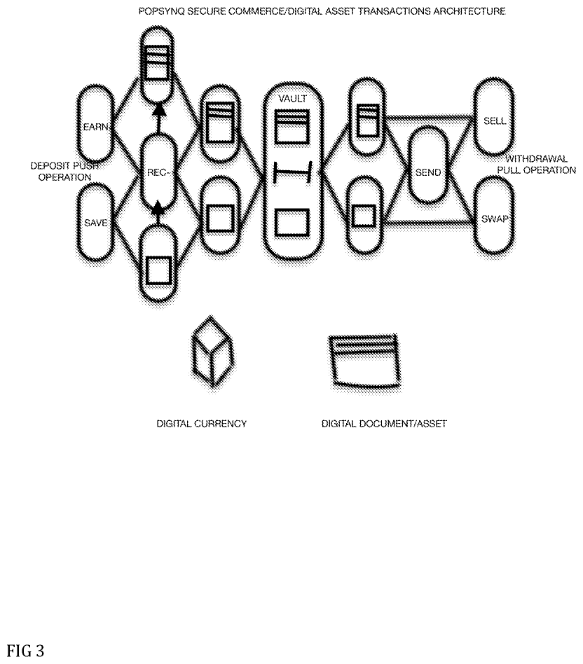

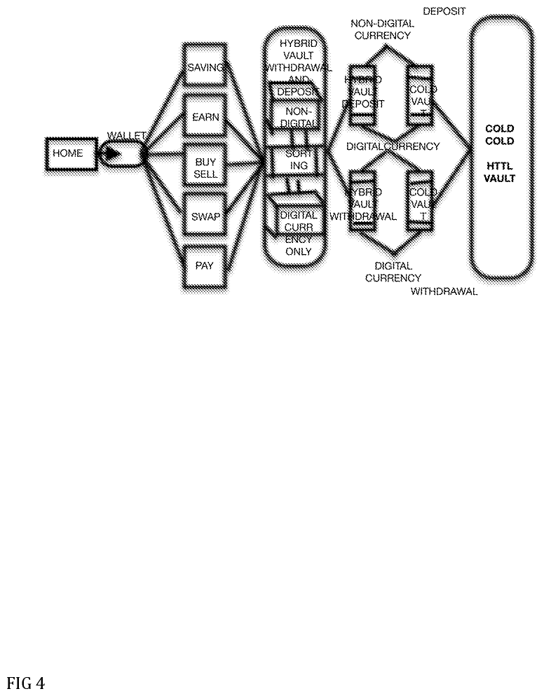

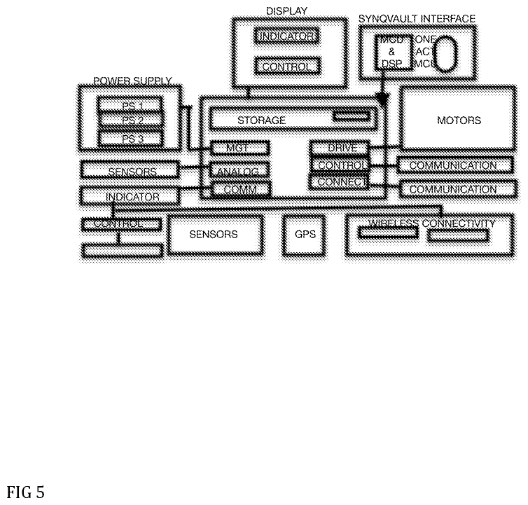

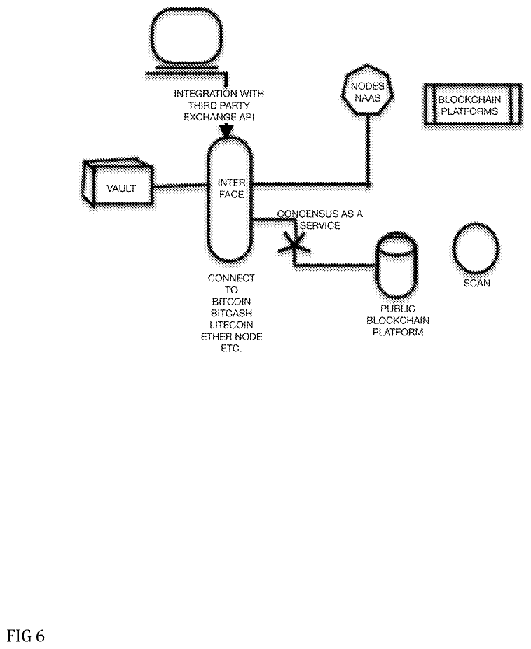

Illustrate single-act and gesture withdraw and deposit in one embodiment of the present invention, where the transaction brief are the various display to carry out one act withdrawal or deposit, which sends the operation command to vault processor and can be cancelled later in a situation of change of mind within a certain timeframe. For one act and gesture withdrawal or deposit to be effective the vault settings have to be customized based on the transactions, cancel timeframe and to differentiate digital asset categories within Synqvault such as digital currency and digital documents which have compartments for share, favorites, search, organize, and secure folders.

The customize transaction cancel time FIGURE section illustrate one act and gesture withdrawal or deposit transaction process to the Synqvault storage link vault block which recognizes the act swiftly and process the data to carryout the command acting as the single act and gesture control unit to progress with command or to review one act and gesture withdrawal or deposit transaction requirement, the final transactions of operation describing a transaction that may be withdrawn deposit. This operation was sent from the device system to the embedded Synqvault system when the user requested.

In general, the user need only be aware of the transaction or asset to withdraw or deposited by the single act or gesture and implement accordingly using various formats like biometrics one act access and verification system for withdraw and deposit which is an additional operation option.

The Synqvault transfer section provides the conventional capability to add the described transaction to a vault block transfer. The encrypted system predetermines every transaction for review based on the timeframe set by the device owner during setup and rightly implemented at the sequence of a single act and gesture.

Once the user activates the single gesture or act, displays withdraw or deposit discharge instantly, unless the user then takes some action to modify the withdraw or deposit such as cancel the transaction within the timeframe or pause to review before final transactions are carried out. The withdraw and deposit mechanism section contains adequate data so that the shared user can verify that the encrypted system correctly recognizes the user, which reduce the chances of operational data being intercepted. The encrypted system sends only adequate data so that the user is confident that the encrypted system correctly identified the user, yet not adequate data to be useful to an unscrupulous interceptor. The setting plays a major role in response to this selection, the encrypted system may require the user to perform a “login” so that the identity of the user can be verified before the displayed data is viewed or modified. The encrypted system then stores up the credentials to the interface system for display and possible modification as needed.

FIG. 2

Illustrate a block FIGURE embodiment of the present invention with one act and gesture withdrawal and deposit access verification control system, using deposit push and withdraw pull mechanism to carry out transactions confirmation. The embedded Synqvault system sends a one-time passcode and instructs user to enter the unique requirement assigned to establish a secured progression and access activating with notification the assigned device indicator [ADI], encrypted data scanner [EDS] and foreign data detect [FDD] to verify for system infiltration, spyware, privacy violation, hacker attack warning, identity key theft, fraud security breach and virus detection, prior to initiating final access to the embedded Synqvault system specifically single act and gesture withdraw or deposit.

In address data stored in one embodiment synqvault system assigns and sends data to the device system with encryption while allowing the combined hybrid wallet mechanism to operate as a standalone block. The hybrid block is a cold and hot wallet but not a Synqvault block. The hybrid wallet uses a decentralized application that is built on top of two protocols: a decentralized protocol and an exchange protocol. The decentralized protocol is a non-native protocol used to coordinate a network of nodes to form consensus around the outcomes of real-world events by providing the nodes with incentives via integrity token. The exchange protocol is a non-native network protocol that facilitates gesturing between senders and receivers, allowing token swap. The functionality of each protocol is independent of the other, the sets of nodes utilizing each protocol don't necessarily overlap, and each protocol could be used for a variety of applications unrelated. These characteristics allow the protocols to be decoupled from each other and from any particular application or use case.

The single-act and gesture withdraw and deposit technique is an intrinsic system designed also for enterprise deployment other than the consumer devices or platforms. These systems may include revenue collection-based systems or other payment mechanism providing exceptional accountability and asset storage.

Methods for encrypting data are included in the system. This is effective since there is no need for device system utilities to know the encryption seed to effectively manage the data. The risks of relying on encryption include the fact that an attacker can copy the data and use brute force to decrypt the data. Losing the seed means losing the data.

Barred vault system tries to maintain integrity, one significant responsibility of the Synqvault system is to ensure that, regardless of the actions by programs accessing the data, the structure remains consistent. This includes actions taken if a program modifying data terminates abnormally or neglects to inform the system that it has completed its activities. This may include updating the metadata, the directory entry and handling any data that was buffered but not yet updated on the physical storage. Other failures which the system has in consideration include communication failures or loss of connection to remote systems. In the event of an operating system failure or “soft” power failure, special routines in the Synqvault system must be invoked similar to when an individual program fails.

The Synqvault system is able to correct damaged structures. These may occur as a result of an operating system failure for which the operating system was unable to notify the Synqvault system, power failure or reset. The Synqvault system also records events to allow analysis of systemic issues as well as problems with specific vault block or catalogs.

FIG. 3

Illustrates the display operation representing two main command with two auxiliary string commands. A functional modeling perspective concentrates on the dynamic process. The main concept in this modeling perspective is the process, this could be a function, transformation, activity, action, task etc. A well-known example of a modeling language employing this perspective is data Synqvault flow. The perspective uses cryptograms to describe the process, these being: Process: Illustrates transformation from input to output, store: data-collection or some sort of material, flow: movement of data or material in the process, and external Entity: External to the modeled embedded Synqvault system, but interacts with it. The sorting system blocking the data that can be passed over as digital document or currency to the hybrid wallet until effectively scanned for system infiltration, spyware, privacy violation, hacker attack warning, identity key theft, fraud security breach and virus detection then progresses to effect single-act and gesture withdrawal or deposit.

The FIGURE illustrates an embodiment of the present invention. This embodiment supports send or receive single act and gesture withdraw Synqvault pull [WVP] and deposit Synqvault push [DVP], these are incoming and outgoing digital data with display and gesture recognition to also buy, earn, swap, sell, save or vault etc., earn and swap operate interchangeable with pull or push withdraw and deposit exchange functionalities based on the selected or available digital asset.

The system identifies digital asset ranging anywhere from motion pictures to documents and any other type of data one can think of. The system sorts cryptocurrency separately, whereas digital assets issued on a distributed ledger format are kept same way. The system operate cryptocurrency with encryption techniques used to regulate the generation of units of currency and verify the transfer of funds, operating independently, allowing the owner to be in full control at all times, (public and private key system) associated with cryptocurrency wallets. This Synqvault command system control, hybrid transfer system, Synqvault offline exclusion and online inclusion hybrid mechanism integrated for the cold and hot wallet makes it dynamic for transactions to be effective.

FIG. 4

Synqvault transaction verification is a flow FIGURE of a method to generate an operation of digital asset differentiation mechanism single act and gesture withdraw or deposit. There are major differences in the digital asset currency system setup. Though cryptocurrencies are a variant of digital currencies, there are some key differences in the system (e.g., digital currencies are centralized, meaning that transaction within the network is regulated in a centralized location, like a bank. Cryptocurrencies are decentralized, and the regulations inside the network are governed by the majority of the community. Digital currencies are not transparent. With digital currencies, you cannot choose the address of the wallet and see all money transfers since the beginning of time. This information is kept strictly confidential and private. Cryptocurrencies are transparent. Anyone and everyone is able to see any and all transactions made and received by any user, as all revenue streams are placed in a public chain—the blockchain).

Synqvault distribution framework surrounding digital document and currency is for when single act and gesture withdraw or deposit is enabled, the system generates an operation describing the transaction as is conventionally done and then adds a single act and gesture withdraw and deposit section. In this embodiment, the system adds partial user-specific withdraw and deposit before it gets to the final transactions for the sake of user review section. This data may include the user's name, display selected by the user (e.g., “send”), and the transactions selected by the user. Such partial data is sufficient to indicate to the user whether or not the system is using the correct user-specific withdraw and deposit command.

FIG. 5

This is a flow diagram method which processes cold state wireless connectivity transfer Synqvault, shared remote access notification, one act and gesture withdraw and deposit, multiple device synchronization, one act digital asset synchronization, dual-access key system in a single-act and gesture withdraw and deposit. When a user performs the single act needed to establish a withdraw and deposit, the device system notifies the encrypted system. The system then combines the user-specific withdraw and deposit data for use associated particularly with that device system transaction.

The gesture application is mainly in augmented and virtual environment control, but also in sign language translation, remotely controlled robotics, content creation. Synqvault system deploys recognition of human gestures within a more general framework of pattern recognition. In this framework, systems consist of two processes: the representation and the decision processes. The representation process converts the raw numerical data into a form adapted to the decision process which then classifies the data. While gesture recognition may reduce the need for handheld devices, yet another avenue could lead to a vast infusion of specialized input devices. The Synqvault system differentiate gestures by separating the static gestures, and the dynamic gestures which are sequences related. Synqvault recognition task information can be crucial to distinguish gesture classes from one act, device synchronization and digital data synchronization.

Synqvault system conduct interpretation of human gestures using various inputs and computational processing system that controls and activates simple gestures. Application Synchronization requires one act to activate the hybrid wallet during synchronization and the remote database must be inside the local network or virtual encrypted private network in order for changes to transfer between platforms. The Synqvault system allows synchronization to take place across encrypted network compatibility. Synqvault also allows synchronization to take place when a remote synchronization user is outside of the network by using an Internet connection only to the hybrid wallet.

Vaultstamp-based synchronization method is the most useful general technique for efficient synchronization. The technique involves tracking the last data that each user synchronized within the Synqvault system and using this information to control the rows downloaded to each remote database. In this case all changes to the data are marked with vaultstamps. Synchronization proceeds by transferring all data with a vaultstamp later than the previous synchronization.

FIG. 6

This Synqvault flow diagram of a method for generating a single-act gesture withdraw and deposit managing system with sensors, contrivance and task. The Synqvault approach divides the functionality into several smaller sub-systems to create a decentralized and dynamic system with better maintainability, advanced dependability, enhanced error forbearance, and a more adaptable distribution of tasks.

We claim:

1. A method of withdraw and deposit for a transaction comprising: under control of a device system, displaying data identifying the digital data; and in response to only a one act being performed, sending a request to withdraw or deposit the transaction along with a key of a user of the transaction to an encrypted system; under control of a one act gesture withdraw or deposit component of the encrypted system, receiving the request; retrieving additional data previously stored for the user identified by the key in the received request; and generating withdraw or deposit to process the requested transaction as identified by the key in the received request using the retrieved additional record; and fulfilling the generated withdraw or deposit to complete the act of the digital data whereby the transaction is withdraw or deposited from the embedded synqvault system.

2. The method of claim 1 wherein the displayed device indicators utilize digital asset data transfer which includes secured communication and connectivity to activate one act, gesture withdraw or deposit.

3. The method of claim 1 wherein the one act withdraw or deposit is a button.

4. The method of claim 1 wherein the one act withdraw or deposit is speaking of a sound.

5. The method of claim 1 wherein the one act withdraw or deposit is movement of a body part.

6. The method of claim 1 wherein a user of the device system does not need to explicitly identify themselves when engaged with withdraw or deposit.

7. A device system for withdraw or deposit transaction comprising: a key that identifies a user; a display component for displaying data identifying the digital data; separating the digital asset; utilizing vaultstamp system to enhance secured transaction; hybrid wallet connectivity and communication to synqvault and vaultstamp; hybrid wallet multi-device synchronization one act, gesture withdraw or deposit component that in response to performance of only a one act, sends a request to an encrypted system to withdraw or deposit the identified digital asset data, the request including the key so that the system can locate additional data needed to complete the withdraw or deposit and so that the system can fulfill the generated withdraw or deposit to complete exchange of the digital asset data using vaultstamp and embedded synqvault withdraw and deposit control system component that in response to performance of multiple display lock-in action, to send request to the system to carry out the requested transaction to and from a vault transfer.

8. The device system of claim 7 wherein the vaultstamp component is a component within the embedded synqvault system to track trustzone and natal withdraw or deposit.

9. The embedded synqvault system of claim 7 wherein the predefined action is the act of establishing a natal and trustzone withdrew or deposit transaction vaultstamp.

10. Multiple vault synchronization synqvault access system of claim 7 wherein the predefined action is the act of a displayed button or gesture movement recognition and control command system.

11. The HTTL vault (mother-vault) system is an encrypted system for generating withdraw and deposit comprising: a vault transfer withdraw or deposit component; and a one act, gesture withdraw or deposit component including: a digital asset data storage medium storing data for a plurality of users; a receiving component for receiving requests to withdraw and deposit digital asset data, a request including an indication of one of the plurality of users, the request being sent in response to only a one act performed; withdraw and deposit establishment component that retrieves from the digital asset data storage medium data for the designated user and that uses the retrieved digital asset data to establish withdraw or deposit for the designated user for the digital asset data; and withdraw or deposit fulfillment component that completes an exchange of the transaction in accordance with the withdraw and deposit established by the one act, gesture withdraw and deposit component.

12. The system of claim 11 wherein the request is sent by the HTTL system in response to a one act withdraw or deposit being performed.

13. A method for withdraw and deposit transaction using vaultstamp and synqvault system, the method comprising: Displaying digital asset data identifying the transaction and displaying an indication of a one act that is to be performed to withdraw and deposit the identified digital asset data; and in response to only the designated one act being performed, sending to an encrypted system a request to withdraw or deposit the identified digital asset data whereby the transaction is withdrawn or deposited independently of a vault block transfer model and the withdraw and deposit is fulfilled to complete an exchange of the digital asset data.

14. The method of claim 11 wherein the system uses a key sent along with the request to identify additional data needed to generate withdraw and deposit for the digital asset data.

15. The method of claim 12 wherein the key identifies the device system and the embedded synqvault system provides the key to the vaultstamp for the utilization of the HTTL vault system.

16. The method of claim 11 wherein the device system and the embedded synqvault and vaultstamp system communicate via connectivity for offline purposes only.

16. The method of claim 11 wherein the device system and the hybrid wallet system communicate withdraw or deposit via the internet.

16. The method of claim 11 wherein the device system, the embedded synqvault and vaultstamp system communicate via remotely synchronized stationary withdraw or deposit transaction.

17. The method of claim 11 wherein the displaying includes transmitting of one time passcode, and passphrase provided by the encrypted system for withdraw or deposit.

18. The method of claim 11 including sending from the vaultstamp system to the device system a confirmation that the withdraw or deposit was generated.

19. The method of claim 11 wherein the one act is a displayed button when a cursor is positioned over a predefined area of the displayed withdraw or deposit record.

20. The method of claim 11 wherein the one act is a sound generated withdraw or deposit by a user.

21. The method of claim 11 wherein the one act is selection of withdraw or deposit using a gesture recognition control.

22. The method of claim 11 wherein the one act is activating of a key on a key pad for withdraw or deposit by way of depressing.

23. The method of claim 11 wherein the one act is selecting withdraw or deposit using a pointing device.

24. The method of claim 11 wherein the one act is selection of a displayed withdraw or deposit control.

25. The method of claim 11 wherein the displaying includes partial withdraw or deposit digital asset data supplied by the system as to the identity of a user of the hybrid wallet and the embedded synqvault system vaultstamp.

26. The method of claim 11 the displaying includes displaying partial withdraw or deposit displayed digital asset data supplied by encrypted synqvault and vaultstamp exchange.

27. The method of claim 11 wherein the displaying includes displaying partial withdraw or deposit digital asset data supplied by encrypted synchronization, gesture recognition, sensor and connectivity system.

28. The method of claim 11 wherein the displaying includes displaying a withdraw and deposit combination identifying natal and trustzone of the user(s).

29. The method of claim 11 wherein the displaying includes display withdraw or deposit time lapse identifying a displayed natal and trustzone for the user(s).

30. The method of claim 11 wherein the displaying includes displaying withdraw or deposit dual-access identifying a displayed natal and trustzone of the user(s)

31. The method of claim 11 embedded synqvault and vaultstamp system one act withdraw or deposit comprising: a smart vault technique when integrated with a stationary or multiple commercial vault with synqvault technology identifies users; display component for displaying digital asset data identification with one act, gesture withdraw or deposit component in response to perform only a single act, send a request to an encrypted system to withdraw or deposit the identified digital asset data, the request including the key so that the system can locate additional data needed to complete the withdraw or deposit and so that the system can fulfill the generated withdraw and deposit to complete exchange of the digital asset data using vault transfer withdraw and deposit component which also perform multiple lock-in action, to send request to the vault block system.
The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, quantum hard storage drives, solid state drives, and optical data storage devices. The computer readable medium can also be distributed over network-coupled computer systems so that the computer readable code is stored and executed in a distributed method.
The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above instructions.
Although the present invention has been described in terms of various embodiments, it is not intended that the invention be limited to these embodiments. Modification within the essence of the invention will be apparent to those skilled in the art. For example, the embedded synqvault system can chart and synchronize a user identifier to multiple devices with accesses remotely by the user to access the hybrid wallet and vault block system. The embedded synqvault system can then allow the user to identify by a single act of the process and synchronization based preferably on a display of partial gesture or withdrew and deposit-specific requested information. Also, numerous separate one act can be used to trigger withdraw or deposit. For example, a gesture command may be engaged by the withdrew or deposit, a key may be depressed by the user, a button on a remote-control device may be depressed by the user, or selection using any pointing device may be influenced by the user. Although a single act may be activated by numerous material movements of the user, the single act generally refers to a single occurrence received carried out by a user system that indicates to withdrew or deposit. Finally, the user can be alternately identified by various unique identifiers that is provided by the user when the user initiates access to the embedded synqvault system and sent to the device system. The scope of the present invention is defined by the claims that follow.
